(19) United States
(12) Patent Application Publication
(10) Pub. No.: US 2026/0015104 A1
(43) Pub. Date: Jan. 15, 2026

(54) ROCKET STAGE AND METHOD OF LANDING THEREOF

(71) Applicant: Tehiru, Inc., New York, NY (US)

(72) Inventor: Aaron PRAT, New York, NY (US)

(21) Appl. No.: 18/993,752

(22) PCT Filed: Jul. 13, 2023
(86) PCT No.: PCT/IB2023/057192

§ 371 Date: Jan. 13, 2025

(30) Foreign Application Priority Data
Jul. 13, 2022 (IL) 294757

(51) Int. Cl. B64G 1/00; B64G 1/22; B64G 1/24; B64G 1/36; B64G 1/40; B64G 1/62

(52) U.S. Cl. CPC B64G 1/006; B64G 1/2222; B64G 1/2421; B64G 1/36; B64G 1/4005; B64G 1/623

(57) ABSTRACT

A stage of a rocket is disclosed. The rocket stage may include: a body, and a plurality of foldable propulsion units spaced around a circumference of the body, where each propulsion unit comprises: a folding beam; at least one motor mounted to the folding beam, and at least one propeller mounted to the at least one motor, configured to generate a thrust to propel the rocket.

### CROSS-REFERENCE TO RELATED APPLICATIONS

This application claims the benefit of priority of IL Application No. 294757, titled “ROCKET STAGE AND METHOD OF LANDING THEREOF”, filed on Jul. 13, 2022, the contents of which are incorporated herein by reference in their entirety.

### FIELD OF THE INVENTION

The present invention relates generally to spacecraft. More specifically, the present invention relates to rocket stages, and re-usable rocket stages with landing capabilities.

### BACKGROUND OF THE INVENTION

The advancements in commercial spacecraft have led to innovative developments in reusable rocketry. Previously, when a rocket was launched into space, its boosters were single-use and decommissioned after each use. In the modern era, booster stages (i.e., stages of rockets used to get a launch vehicle past the Earth's atmosphere) are reusable, and conventionally use the same fuel for launching and landing. For example, a Falcon™ Heavy booster from SpaceX™ uses a mixture of liquid oxygen (LOX) and rocket-grade kerosene propellant for launch and landing. Thus, approx. 2% of the total propellant available at liftoff needs to be saved and used for landing.

Additionally, using liquid propellant for landing a spacecraft provides additional risks. On the landing trajectory, aerodynamic control (i.e., yaw, pitch, and roll stability) is mostly achieved through aerodynamic control surfaces; in the art, grid or lattice fins are used for aerodynamic control. For statically mounted thruster engines, a thrust provided by the engine is unidirectional; therefore, the engines must work in parallel with the lattice fins to control the landing stage. For thruster engines incorporating thrust vectoring (or TVC as known in the art), the aerodynamic control is limited to the maximum rotational range of the engines (i.e., along a pitch and yaw axis), combined with the thrust produced in the desired vector. In such cases, the aerodynamic control is further limited to the distance between the engine and the rocket's center of mass, for example, in order to create a moment around the rocket's center of mass. In conventional rocketry, the engine location is limited to the bottom of the rocket.

Furthermore, the added complexity of using a single engine as both a thrust vector controller and a means for slowing down the rocket provides additional risks. During a landing maneuver, small corrections must be taken in fractions of seconds in order to land safely. If an engine is utilized for thrust vectoring control, the response time of actuators rotating the engine to the desired configuration may be slower than the required response time for correction maneuvers.

Another risk for liquid propellant-powered landing is the proximity of the thruster engines to the landing surface (or landing pad). If a thrust is miscalculated, or the landing gear fails to deploy, the thruster engine may make direct contact with the landing pad while the engine is producing thrust. This can lead to instantaneous fatal damage to the spacecraft and the surrounding area (i.e., upon the exhaust vent becoming closed by contacting the landing pad, causing a significant amount of backpressure in the engine).

Additionally, recovery of liquid propellant-powered rockets needs to be executed in remote areas, for example, areas dedicated to rocket launch and landing. These remote areas need to be far away from inhabited regions for concerns of safety, noise ordinance, and fumes from propellant. With the recent increase of frequency for commercial spaceflight launches, launch schedules may be limited by the availability of these remote areas capable of facilitating launch and landing of liquid propellant-powered rockets.

Thus, a solution is required that reduces risk of fatal accidents upon rocket landing while increasing turnaround time on launch frequency.

### SUMMARY OF THE INVENTION

Embodiments of the present invention are directed to a stage of a rocket. Embodiments of the rocket stage may include: a body, and a plurality of foldable propulsion units spaced around a circumference of the body, where each propulsion unit comprises: a folding beam; at least one motor mounted to the folding beam, and at least one propeller mounted to the at least one motor, configured to generate a thrust to propel the rocket.

In some embodiments, the rocket stage may include a plurality of foldable airbrakes spaced around a circumference of the body, where each airbrake comprises at least one airbrake actuator, configured to actuate the plurality of foldable airbrakes.

In some embodiments, the rocket stage may include at least one first sensor configured to measure a value indicative of the altitude of the rocket stage, where the at least one airbrake actuator is configured to unfold the plurality of foldable airbrakes in response to receiving a first value indicative of the altitude of the rocket stage from the at least one first sensor.

In some embodiments, each foldable propulsion unit comprises at least one beam actuator, configured to unfold the folding beam.

In some embodiments, the rocket stage may include at least one second sensor configured to sense at least one flight characteristic of the rocket.

In some embodiments, the beam actuator is configured to unfold the folding beam in response to receiving a second value indicative of the altitude of the rocket stage from the second sensor or the first sensor. In some embodiments, the at least one second sensor is selected from: an altimeter, a pressure sensor, an accelerometer, a gyroscope, and a magnetometer.

In some embodiments, the rocket stage may include a controller configured to control the folding and unfolding of each foldable propulsion unit based on measurements received from the second sensor or the first sensor. In some embodiments, the controller is configured to control the plurality of foldable propulsion units to maneuver the rocket stage. In some embodiments, the controller is configured to control the plurality foldable propulsion units to change at least one of: a pitch angle, a roll angle, and a yaw angle of the rocket.

In some embodiments, each foldable propulsion unit further comprises at least one servo, and the controller is configured to control the at least one servo to change a pitch of the at least one propeller.

In some embodiments, the rocket stage may include a plurality of stabilizer fins, spaced around a circumference of the body.

Embodiments of the present invention are directed to a rocket system. Embodiments of the rocket system may include: a payload; a first stage comprising: a body; and a plurality of foldable propulsion units spaced around a circumference of the body, and a second stage.

In some embodiments, the first stage of the rocket system further comprises: a plurality of foldable airbrakes spaced around a circumference of the body, wherein each airbrake comprises at least one airbrake actuator, configured to actuate the plurality of foldable airbrakes.

In some embodiments, each foldable propulsion unit of the first stage comprises: a folding beam; at least one motor mounted to the folding beam, and at least one propeller mounted to the at least one motor, configured to generate a thrust to propel the rocket.

Embodiments of the present invention are directed to a method of maneuvering a stage of a rocket. Embodiments of the method may include: detecting a first altitude and/or velocity of a rocket stage; unfolding a plurality of foldable propulsion units of the rocket stage; activating at least one motor of the foldable propulsion units, and generating a thrust, via at least one propeller mounted to the at least one motor, in order to maneuver the rocket stage, wherein the rocket stage comprises: a body; and the plurality of foldable propulsion units spaced around a circumference of the body, wherein each propulsion unit comprises: a folding beam; at least one motor mounted to the folding beam, and at least one propeller mounted to the at least one motor, configured to generate a thrust to propel the rocket.

In some embodiments, the method may include: detecting a second altitude and/or velocity of the rocket stage, and unfolding a plurality of foldable airbrakes, wherein the rocket stage further comprises a plurality of foldable airbrakes spaced around a circumference of the body.

In some embodiments, unfolding the plurality of foldable airbrakes is controlled by at least one airbrake actuator of the foldable airbrakes.

In some embodiments, unfolding the plurality of foldable propulsion units is controlled by at least one beam actuator of the foldable propulsion units.

In some embodiments, the method may include maneuvering the rocket stage, via the at least one propeller, in order to change at least one of: a pitch angle, a roll angle, and a yaw angle of the rocket stage.

In some embodiments, the method may include maneuvering the rocket stage, via a plurality of stabilizer fins located on the rocket stage and configured to actuate with respect to a longitudinal axis thereof, in order to change at least one of: a pitch angle, a roll angle, and a yaw angle of the rocket stage.

In some embodiments, the method may include landing the rocket stage, via the plurality of foldable propulsion units. In some embodiments, landing the rocket stage is on one of: a ground surface, and a marine vessel.

Embodiments of the present invention are directed to a method of launching and landing a rocket. Embodiments of the method may include: launching the rocket from one of: an aircraft or a ground surface; controlling the rocket to achieve a desired altitude and/or velocity; separating a first stage of the rocket from a second stage thereof, and landing the first stage, via a plurality of foldable propulsion units of the first stage, wherein the rocket comprises: a payload; a first stage, and a second stage, wherein the first stage comprises: a body; and a plurality of foldable propulsion units spaced around a circumference of the body, wherein each propulsion unit comprises: a folding beam; at least one motor mounted to the folding beam, and at least one propeller mounted to the at least one motor, configured to generate a thrust to propel the rocket.

In some embodiments, the first stage further comprises: a plurality of foldable airbrakes spaced around a circumference of the body, wherein each airbrake comprises at least one airbrake actuator, configured to actuate the plurality of foldable airbrakes.

In some embodiments, landing the first stage is on one of: a ground surface, and a marine vessel.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an illustration of a rocket stage according to some embodiments of the invention;

FIG. 2 shows an illustration of a rocket stage according to some embodiments of the invention;

FIGS. 3A and 3B show top view and side view illustrations of stabilizer fins which may be included in a rocket stage according to some embodiments of the invention;

FIG. 4 shows a block diagram, depicting a control system which may be included in a rocket stage according to some embodiments of the invention;

FIG. 5 shows a block diagram, depicting a computing device which may be included in a rocket stage according to some embodiments of the invention;

FIG. 6 shows a block diagram, depicting a rocket system according to some embodiments of the invention, and

FIG. 7 is a flow diagram of a method of landing a rocket stage according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Some aspects of the present invention are directed to a rocket stage, which may have landing capabilities or be combined with an additional rocket stage (e.g., a booster stage) in order to land the additional rocket stage. In some embodiments, landing the rocket stage may be controlled by activating one or more electric motors (also called “drone motors”), which may produce a thrust via one or more propellers mounted to the one or more drone motors, in order to control a landing of the rocket stage. In some embodiments, landing the rocket stage may comprise opening a plurality of airbrakes, located on the rocket stage body, in order to reduce a velocity of the rocket stage.

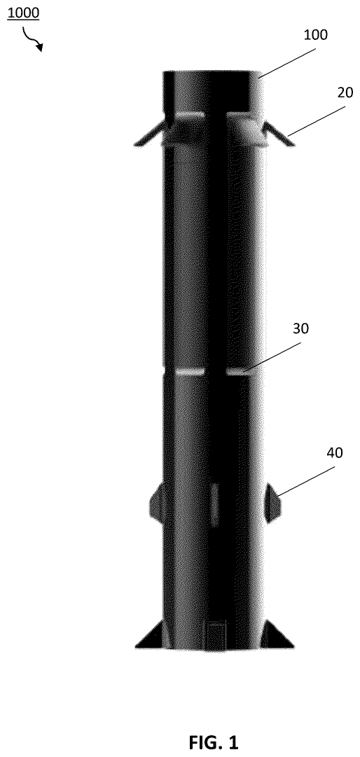

Reference is now made to FIG. 1 showing an illustration of a rocket stage in a folded state according to some embodiments of the invention. A rocket stage 1000, in some embodiments, may include a body 100. Body 100 may be a conventional rocket body as used in the art, for example, an aluminum alloy shell.

Rocket stage 1000 may further include a plurality of foldable airbrakes 20. In some embodiments, the plurality of foldable airbrakes 20 may be spaced around a circumference of body 100. In some embodiments, the plurality of foldable airbrakes 20 may be spaced evenly (e.g., equidistantly located) around a circumference of body 100. In a non-limiting example, between 4 to 12 airbrakes 20 may be spaced around a circumference of body 100.

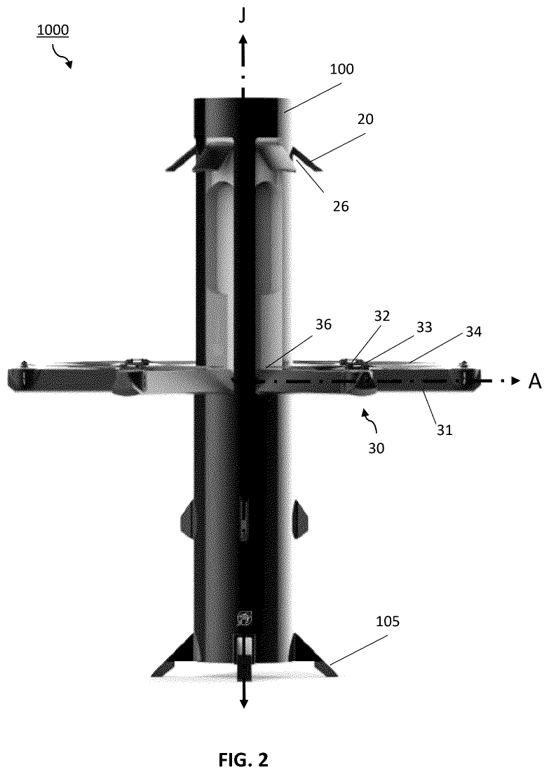

Rocket stage 1000 may further include a plurality of foldable propulsion units 30. In the illustration of FIG. 1 foldable propulsion units 30 are in a folded state and do not use for propelling rocket stage 1000. In some embodiments, foldable propulsion units 30 may be spaced around a circumference of body 100. In some embodiments, the plurality of foldable propulsion units 30 may be spaced evenly around a circumference of body 100. Foldable propulsion units 30 may be configured to unfold (i.e., extend away from body 100), further discussed herein with respect to FIG. 2. In a non-limiting example, between 3 to 12 foldable propulsion units 30 may be spaced around a circumference of body 100.

Rocket stage 1000 may further include a plurality of stabilizer fins 40. In some embodiments, stabilizer fins 40 may be spaced around a circumference of body 100. In some embodiments, the plurality of stabilizer fins 40 may be spaced evenly (e.g., equidistantly located) around a circumference of body 100. Stabilizer fins 40 may be comprised of solid fins, i.e., wing-like shapes with an outer “skin” shell. In some embodiments, stabilizer fins 40 may be, or may include, grid or lattice fins (i.e., fins comprising a honeycomb-like pattern allowing for air to pass through a plurality of holes along a face of the fin), as known in the art. Stabilizer fins 40 may be located at any predetermined location along a longitudinal length of body 100, as may be required based on desired performance characteristics of rocket stage 1000.

Reference is now made to FIG. 2 showing an illustration of a rocket stage where foldable propulsion units 30 are in an unfolded state according to some embodiments of the invention. In some embodiments, body 100 may comprise landing gear (or “legs”) 105, located at the bottom of the body 100. Landing gear 105, as known in the art, may be used to stabilize rocket stage 1000 upon landing (e.g., for landing on a landing pad). Each foldable propulsion unit 30 may comprise a folding beam 31, at least one motor 32 mounted to folding beam 31, and at least one propeller 34 mounted to at least one motor 32, configured to generate a thrust to propel rocket stage 1000.

Each folding beam 31 may be a structural beam mounted to body 100. In some embodiments, a material composition of each folding beam 31 may be selected from non-limiting examples, including: carbon fiber, Kevlar®, plastics (e.g., acrylonitrile butadiene styrene or “ABS” plastic), aluminum alloys, and steel alloys.

The at least one motor 32 may be an electric motor and may be selected based on requirements of the intended use (e.g., desired thrust capabilities). Each motor 32 may be powered by a power source (not illustrated), which may be selected from non-limiting examples, including: lithium-ion polymer (“LiPo”) batteries, solid state batteries, super capacitors, chemical batteries, hybrid systems (e.g., thermal and electric), thermal systems, and the like. Power source selection may be based on required specifications of the at least one motor 32, for example, required discharge rate (or “C” rating, as known in the art). At least one propeller 34 may be mounted to each of the at least one motor 32 (e.g., two propellers 34 mounted to one motor 32).

Each foldable propulsion unit 30 may comprise a folded (as illustrated in FIG. 1) and unfolded state pertaining to the orientation of propulsion unit 30 and more specifically the orientation of propeller 34. In the folded state, a longitudinal axis A of folding beam 31 may be parallel to a longitudinal axis J of body 100. In the unfolded state, the longitudinal axis A of folding beam 31 may be set at an angle (e.g., 70-110 degrees, 60-90 degrees, 90-100 degrees and any range and value herein between) with respect to the longitudinal axis J of body 100. In some embodiments, the longitudinal axis A of folding beam 31 may be perpendicular (i.e., set at 90 degrees) to the longitudinal axis J of body 100, as illustrated in FIG. 2.

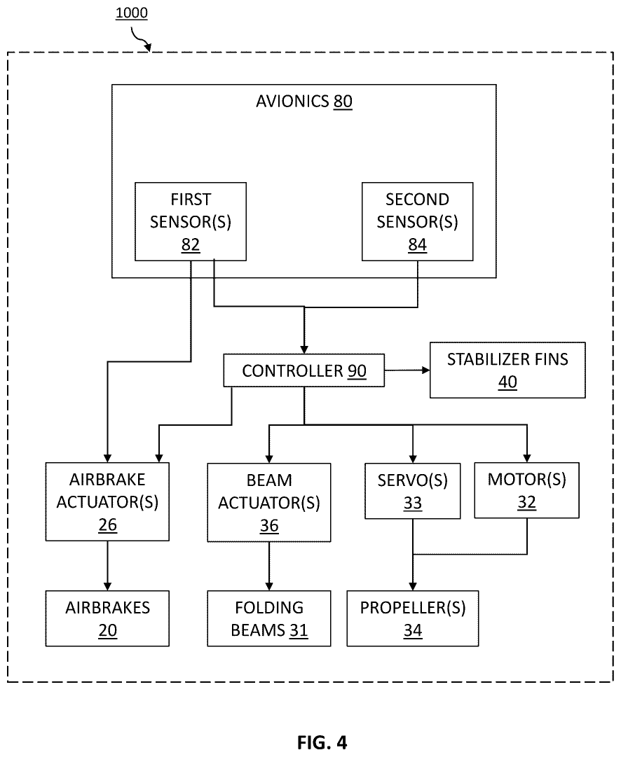

In the unfolded state at least one propeller 34 may be configured to generate a thrust to propel the rocket stage 1000, for example, in order to land rocket stage 1000 on a landing pad. In some embodiments, when each folding beam 31 is set at an unfolded state as discussed herein, the at least one propeller 34 may be configured to rotate along a rotational axis of the at least one propeller 34, in order to generate a thrust. In some embodiments, the thrust generated by the at least one propeller 34 may counteract a gravitational force directing rocket stage 1000 towards a surface. Each propeller 34 may comprise a fixed or variable pitch, as known in the art. In cases where the at least one propeller 34 comprises a variable pitch, each foldable propulsion unit 30 may comprise at least one servo 33, further illustrated and discussed with respect to FIG. 4 herein, configured to change a pitch of the at least one propeller 34. The at least one servo 33 may be configured to actuate blades of the at least one propeller 34 with respect to the rotational axis of each propeller 34, and may be selected from non-limiting examples including: electric servo motors, hydraulic actuators, pneumatic actuators and the like. In some embodiments, the at least one servo 33 may be configured to prevent a rotation of the at least one propeller 34 (i.e., by holding propellers 34 in a stationary position), in order to prevent undesired rotation thereof, as known in the art.

In some embodiments, each foldable propulsion unit 30 may comprise at least one beam actuator 36. In some embodiments, the one or more beam actuators 36 may be configured to unfold (i.e., tilt longitudinal axis A of folding beam 31 away from longitudinal axis J of body 100) the one or more foldable propulsion units 30. In some embodiments, the one or more beam actuators 36 may be further configured to fold the one or more foldable propulsion units 30, i.e., tilt the longitudinal axis A of folding beam 31 towards longitudinal axis J of body 100. The one or more beam actuators 36 may be selected from non-limiting examples including: springs, electrical actuators, hydraulic actuators, pneumatic actuators, and the like. A selection of beam actuators 36 may be based on force requirements in order to unfold the plurality of foldable propulsion units 30, i.e., in order to overcome opposing forces (e.g., drag).

In some embodiments, each foldable airbrake 20 may comprise at least one airbrake actuator 26. The one or more airbrake actuators 26 may be configured to actuate the plurality of foldable airbrakes 20. For example, the one or more airbrake actuators 26 may tilt the plurality of foldable airbrakes 20, i.e., tilt a longitudinal axis of foldable airbrakes 20 away from longitudinal axis J of body 100.

In some embodiments, the one or more airbrake actuators 26 may be configured to actuate the plurality of foldable airbrakes 20, in order to achieve a desired orientation of the foldable airbrakes 20. For example, the one or more airbrake actuators 26 may set the plurality of foldable airbrakes 20 at an angle (e.g., 0-1 degrees, 1-5 degrees, 5-15 degrees, 15-45 degrees, 45-90 degrees, and any range and value herein between) with respect to longitudinal axis J of body 100. The one or more airbrake actuators 26 may be selected from non-limiting examples including: springs, electrical actuators, hydraulic actuators, pneumatic actuators, and the like. A selection of airbrake actuators 26 may be based on force requirements in order to actuate the plurality of foldable airbrakes 20, i.e., in order to overcome opposing forces (e.g., drag).

In some embodiments, a rocket stage 1000 may include at least one actuator (not illustrated), configured to actuate both the airbrakes 20 and the foldable propulsion units 30. In such embodiments, the at least one actuator may be configured to actuate the airbrakes 20 significantly similar to the capabilities disclosed herein with respect to airbrake actuators 26. Additionally, the at least one actuator may be configured to unfold the propulsion units 30 significantly similar to the capabilities disclosed herein with respect to beam actuator 36.

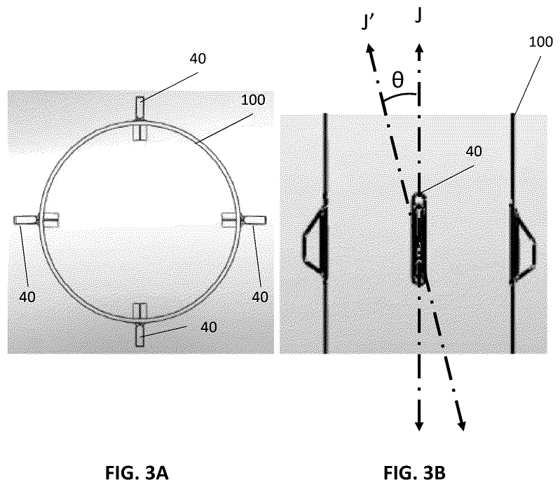

Reference is now made to FIGS. 3A and 3B which are top view and side view illustrations of stabilizer fins which may be included in a rocket stage (e.g., rocket stage 1000) according to some embodiments of the invention. In some embodiments, stabilizer fins 40 may be configured to rotate (or “tilt”) with respect to a longitudinal axis J of body 100. For example, stabilizer fins 40 may be tilted at an angle θ with respect to J, in which a longitudinal axis J′ of stabilizer fins 40 may be set at angle θ with respect to J. In some embodiments, stabilizer fins 40 may be configured to tilt at an angle of 30 degrees, 15 degrees, −15 degrees, −30 degrees and any range and value herein between with respect to longitudinal axis J of body 100. In some embodiments, one or more stabilizer fins may be tilted at a predetermined angle, for example, 5 degrees, in order to produce on the rocket stage at least one of: a pitch moment, a roll moment, and a yaw moment.

Reference is now made to FIG. 4 depicting a control system, which may be included in a rocket stage (e.g., rocket stage 1000) according to some embodiments of the invention.

Rocket stage 1000 may further comprise at least one first sensor 82, and at least one second sensor 84. The at least one first or second sensor 82 or 84 may be selected from: an altimeter, a pressure sensor, an accelerometer, a gyroscope, and a magnetometer. The at least one first sensor 82 may be configured to measure a value indicative of an altitude of rocket stage 1000, where the at least one second sensor 84 may be configured to sense at least one flight characteristic of rocket stage 1000, further discussed herein.

In some embodiments, the at least one first sensor 82 may be configured to send the measured altitude to the at least one airbrake actuator 26. In such embodiments, the at least one airbrake actuator 26 may actuate the plurality of airbrakes 20, based on receiving an altitude measurement from the at least one first sensor 82. An altitude measurement which may induce an actuation of airbrakes 20 may be predetermined by mission parameters, non-limiting examples including: a peak altitude of rocket stage 1000, a velocity measurement (e.g., as measured by at least one of: first sensor 82, second sensor 84, and avionics 80) of rocket stage 1000, and an orientation of rocket stage 1000. In some embodiments, the at least one first sensor 82 may be configured to send the measured altitude (or a “signal” as referred to herein) to controller 90, as further discussed herein.

In some embodiments, the at least one second sensor 84 may be configured to sense at least one flight characteristic of rocket stage 1000. As used herein, a “flight characteristic” may refer to any attribute of rocket stage 1000 or its components thereof, non-limiting examples including: an orientation of one or more of: airbrakes 20, foldable propulsion units 30, and stabilizer fins 40; at least one of: a roll rate, pitch rate, and yaw rate of rocket stage 1000; at least one of: an attitude, altitude, velocity vector, heading, specific force, angular rate, orientation (i.e., with respect to a reference frame, as known in the art), and GPS coordinates of rocket stage 1000; and an indication of power systems' (e.g., power source, motors 32, and propellers 34) status, for example: battery capacity, current load, peak load, discharge rate, motor 32 revolutions per minute, and propeller 34 pitch orientation (or “angle of attack”). In some embodiments, the at least one second sensor 84 may be configured to send one or more measured flight characteristics (or “signals” as referred to herein) to controller 90, in order to control rocket stage 1000 as further discussed herein.

In some embodiments, the at least one first sensor 82 and at least one second sensor 84 may be included within avionics 80, where avionics 80 may be configured to send at least one signal to controller 90. Avionics 80 may be, or may include, an inertial measurement unit (IMU), as known in the art. In some embodiments, avionics 80 may include a single sensor (e.g., an IMU) configured to: sense at least one flight characteristic of rocket stage 1000, and send the sensed flight characteristic (e.g., as a signal) to controller 90.

Rocket stage 1000 may include a controller 90, which may be configured to receive at least one signal from the avionics 80. In some embodiments, controller 90 may be configured to receive at least one signal from the at least one first sensor 82 or the at least one second sensor 84. Controller 90 may control at least one controllable component of rocket stage 1000 based on the one or more received signals. A “controllable component” as referred to herein may be any mechanism or device comprised in rocket stage 1000, non-limiting examples including: airbrake actuators 26, beam actuators 36, servos 33, motors 32, and stabilizer fins 40.

Controller 90 may actuate the one or more airbrake actuators 26, in order to actuate or unfold the plurality of airbrakes 20. For example, controller 90 may release one or more airbrake actuators 26 (e.g., a mechanical spring), in order to unfold the plurality of airbrakes 20. In some embodiments, controller 90 may actuate airbrake actuators 26 (e.g., a pneumatic actuator) at a predetermined orientation, for example, in order to extend airbrakes 20 a predetermined distance away from body 100. In such embodiments, the predetermined orientation may be based on signals received from avionics 80, for example, an altitude measurement.

Controller 90 may actuate the one or more beam actuators 36, in order to actuate the plurality of folding beams 31. For example, controller 90 may release the one or more beam actuators 36 (e.g., a mechanical spring), in order to unfold the plurality of folding beams 31. In some embodiments, controller 90 may actuate beam actuators 36 (e.g., a pneumatic actuator) at a predetermined orientation, for example, in order to extend folding beams 31 a predetermined distance away from body 100. In such embodiments, the predetermined orientation may be based on signals received from avionics 80, for example, an altitude measurement.

Controller 90 may control the at least one servo 33, in order to change a pitch of the at least one propeller 34. In some embodiments, a pitch of the at least one propeller 34 may be controlled by the at least one servo 33, based on signals received from avionics 80, for example, a vibration sensor (e.g., a piezoelectric accelerometer) included in avionics 80 configured to measure a vibration of propellers 34. In such embodiments, for example, upon controller 90 receiving a significantly large frequency of vibration from avionics 80, controller 90 may control the at least one servo 33 to change a pitch of the at least one propeller 34.

Controller 90 may control the at least one motor 32, in order to increase or decrease a rotational speed of propellers 34. In some embodiments, controller 90 may increase a rotational speed of all of the motors 32, in order to generate a thrust to propel rocket stage 1000. As known in the art, motors 32 may be contra-rotating, i.e., a plurality of motors 32 may comprise both clockwise and counterclockwise rotational configurations, in order to counteract a rotational torque which may be caused by increasing or decreasing the rotational speed of propellers 34.

Controller 90 may control the plurality of stabilizer fins 40, in order to maneuver rocket stage 1000. In some embodiments, controller 90 may actuate the plurality of stabilizer fins 40, where a longitudinal axis of at least one stabilizer fin 40 may be tilted at an angle with respect to the longitudinal axis of body 100, as discussed herein. Controller 90 may set at least one stabilizer fin 40 at a tilted angle, in order to induce on rocket stage 1000 at least one of: a pitch, a roll, and a yaw moment.

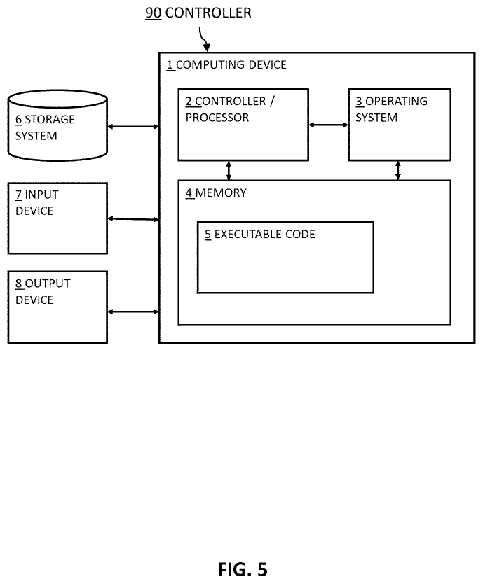

Reference is now made to FIG. 5, which is a block diagram depicting a computing device, which may be included within an embodiment of rocket stage 1000, according to some embodiments of the present invention. In some embodiments, computing device 1 is an embodiment of controller 90, which may be configured to: control the folding and unfolding of each propulsion unit 30, control the plurality of foldable propulsion units 30, control the at least one servo 33, control the at least one airbrake actuator 26, control the at least one beam actuator 36, control the plurality of stabilizer fins 40, and control the at least one motor 32.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under control of operating system 3. Although, for the sake of clarity, a single item of executable code 5 is shown in FIG. 5, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data related to AOI may be stored in storage system 6 and may be loaded from storage system 6 into memory 4 where it may be processed by processor or controller 2. In some embodiments, some of the components shown in FIG. 5 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

In some embodiments, controller 90 may be, or may include, an autonomous flight system (also known as a flight computer). The autonomous flight system may send one or more signals to components or sub-systems of rocket stage 1000, in order to control said components or sub-systems. In some embodiments, the autonomous flight system may be configured to operate with full or semi-full autonomy. For example, controller 90 may automatically (i.e., without any external input) actuate the plurality of airbrakes 20, based on receiving a predetermined altitude measurement from the at least one first sensor 82.

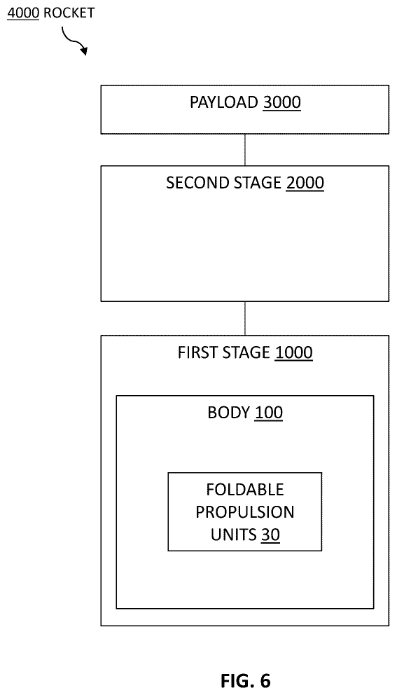

Reference is now made to FIG. 6, which is a block diagram depicting a rocket system according to some embodiments of the invention.

A rocket system 4000 may include a first stage 1000, second stage 2000, and payload 3000. In some embodiments, first stage 1000 may comprise substantially similar elements to rocket stage 1000 discussed herein, including a body 100 and a plurality of foldable propulsion units 30 configured to propel first stage 1000.

Components of rocket system 4000 (e.g., payload 3000 and stages 2000 and 1000) may be interconnected in any order depending on desired mission characteristics. For example, in a launch configuration, a first stage 1000 may be located at a bottom of rocket system 4000, connected to a second stage 2000 located above first stage 1000, connected to payload 3000 located above second stage 2000.

In some embodiments, second stage 2000 may comprise additional thrusters (not illustrated) configured to propel rocket system 4000 to a desired altitude and/or velocity, as known in the art. In such embodiments, additional thrusters may comprise at least one of: a liquid propellant, a hybrid propellant, and a solid propellant, as known in the art. In some embodiments, second stage 2000 may be configured to separate (or detach) from first stage 1000, for example, upon reaching a certain altitude and/or velocity.

In some embodiments, payload 3000 may comprise one or more fairings, as known in the art to reduce a drag coefficient during flight. In some embodiments, payload 3000 may be configured to separate from second stage 2000.

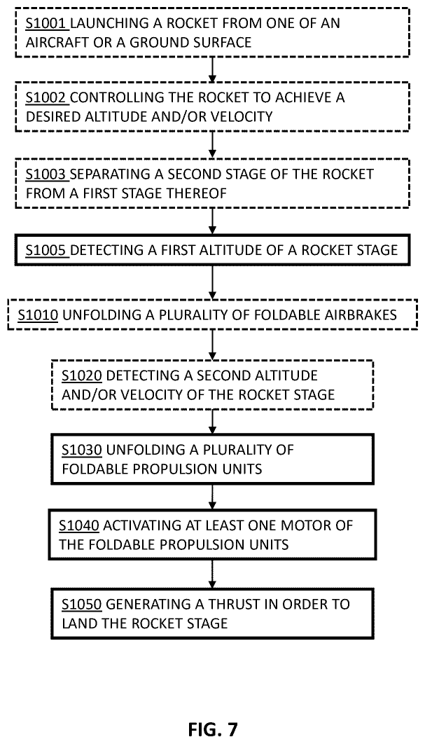

Reference is now made to FIG. 7, which is a flowchart of a method of landing a stage of a rocket according to some embodiments of the invention. In some embodiments, the method of FIG. 7 may also include launching the rocket. In some embodiments, steps S1005 to S1050 may be used to control rocket stage 1000. For example, steps S1005 to S1050 may be used to maneuver rocket stage 1000 during flight or landing (e.g., landing rocket stage 1000 on a surface).

In some embodiments, steps S1005 to S1050 may be performed by controller 90 or by any other suitable controller associated with rocket stage 1000. In some embodiments, steps S1001 to S1050 may be used to launch and land a rocket system 4000. In some embodiments, steps S1001 to S1050 may be performed by controller 90 or by any other suitable controller associated with rocket stage 1000 or rocket 4000.

In step S1001, a rocket (e.g., rocket system 4000) may be launched (or propelled) from one of: an aircraft, or a ground surface. For example, rocket system 4000 may be launched via at least one of: additional thrusters (e.g., conventional propellant rocket thruster engines, as known in the art) comprised within first stage 1000, and additional thrusters comprised within second stage 2000 of rocket system 4000, as discussed herein with respect to FIG. 6.

In step S1002, the rocket may be controlled to achieve a desired altitude and/or velocity of the rocket (e.g., rocket system 4000). For example, controller 90 may monitor an altitude and/or velocity of rocket 4000 (e.g., via avionics 80) until reaching a predetermined measurement thereof, as may be determined by performance or mission requirements.

In step S1003, a first stage (e.g., first stage 1000) of the rocket (e.g., rocket system 4000) may be separated from a second stage (e.g., second stage 2000). For example, controller 90 may separate first and second stages 1000 and 2000 based on a received altitude and/or velocity measurement, e.g., via avionics 80. In some embodiments, a payload (e.g., payload 3000) of rocket system 4000 may be separated (e.g., via controller 90) from second stage 2000, based on a received altitude and/or velocity measurement via avionics 80.

In some embodiments, upon first stage 1000 separating from second stage 2000, first stage 1000 may be controlled to land on a surface, as discussed herein. For example, steps S1005 to S1050 may be used to control first stage 1000 (e.g., via controller 90) to land first stage 1000, as discussed herein with respect to rocket stage 1000.

In step S1005, a first altitude of a rocket stage (e.g., rocket stage 1000) may be detected. In some embodiments, the first altitude may be detected by at least one first sensor 82, configured to send a signal to the plurality of airbrake actuators 26. In some embodiments, the first altitude may be detected by avionics 80 comprising the at least one first sensor 82, configured to send a signal to controller 90, where controller 90 is configured to actuate the plurality of airbrake actuators 26.

In step S1010, a plurality of foldable airbrakes (e.g., foldable airbrakes 20) may be unfolded (or actuated), based on signals received from at least one of: the at least one first sensor 82, and the avionics 80. For example, the plurality of foldable airbrakes 20 may be unfolded, via airbrake actuators 26, based on controller 90 receiving a first altitude measurement from avionics 80. In some embodiments, the plurality of foldable airbrakes 20 may be unfolded in order to reduce a velocity of the rocket stage 1000, for example, during a landing of rocket stage 1000.

In step S1020, a second altitude and/or velocity of the rocket stage (e.g., rocket stage 1000) may be detected. In some embodiments, the second altitude and/or velocity may be detected by at least one second sensor 84. In some embodiments, the second altitude and/or velocity may be detected by the avionics 80 comprising the at least one second sensor 84.

In step S1030, a plurality of foldable propulsion units (e.g., propulsion units 30) may be unfolded (or actuated), based on signals received from at least one of: the at least one second sensor 84, and the avionics 80. For example, the plurality of foldable propulsion units 30 may be unfolded, via beam actuators 36, based on controller 90 receiving a second altitude and velocity measurement from the at least one second sensor 84 and/or avionics 80.

In step S1040, at least one motor (e.g., motor 32) comprised within each foldable propulsion unit 30 may be activated. For example, the at least one motor 32 may begin rotating, thus rotating at least one propeller 34 mounted thereof.

In step S1050, at least one propeller (e.g., propeller 34) may generate a thrust, in order to land the rocket stage (e.g., rocket stage 1000). In some embodiments, controller 90 may control the at least one propeller 34, via motors 32, in order to land the rocket stage 1000. As known in the art, powered propellers (e.g., propeller 34) located around a body (e.g., body 100) may induce aerodynamic changes on the body based on the propellers' rotation speeds and net torques around the body. For example, by applying more thrust to clockwise propellers 34 than counterclockwise propellers 34, a yaw moment may be induced around body 100. In another example, a pitch or roll moment may be induced on body 100 by applying an uneven amount of thrust via propellers 34. In some embodiments, controller 90 may apply equal thrust to all propellers 34, in order to induce a net-zero torque on body 100. In some embodiments, controller 90 may control one or more propellers 34 to induce an aerodynamic change on rocket stage 1000, based on one or more signals received from avionics 80. For example, controller 90 may induce a pitch moment on rocket stage 1000, via propellers 34, based on one or more signals received from avionics 80 detecting an imbalance in pitch. In some embodiments, rocket stage 1000 may land on one of: a ground surface, and a marine vessel, as may be determined by mission characteristics of the flight.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A stage of a rocket, comprising:
a body, and
a plurality of foldable propulsion units spaced around a circumference of the body, wherein each propulsion unit comprises:
a folding beam;
at least one motor mounted to the folding beam, and
at least one propeller mounted to the at least one motor, configured to generate a thrust to propel the rocket.

2. The rocket stage of claim 1 further comprising a plurality of foldable airbrakes spaced around a circumference of the body, wherein each airbrake comprises at least one airbrake actuator, configured to actuate the plurality of foldable airbrakes.

3. The rocket stage of claim 2, further comprising at least one first sensor configured to measure a value indicative of the altitude of the rocket stage, and wherein the at least one airbrake actuator is configured to unfold the plurality of foldable airbrakes in response to receiving a first value indicative of the altitude of the rocket stage from the at least one first sensor.

4. The rocket stage of claim 1, wherein each foldable propulsion unit further comprises at least one beam actuator, configured to unfold the folding beam.

5. The rocket stage of claim 1, further comprising at least one second sensor configured to sense at least one flight characteristic of the rocket.

6. The rocket stage of claim 5, wherein the beam actuator is configured to unfold the folding beam in response to receiving a second value indicative of the altitude of the rocket stage from the second sensor or the first sensor.

7. The rocket stage of claim 5, wherein the at least one second sensor is selected from: an altimeter, a pressure sensor, an accelerometer, a gyroscope, and a magnetometer.

8. The rocket stage of claim 4, further comprising a controller configured to control the folding and unfolding of each foldable propulsion unit based on measurements received from the second sensor or the first sensor.

9. The rocket stage according to claim 8, wherein the controller is further configured to control the plurality of foldable propulsion units to maneuver the rocket stage.

10. The rocket stage according to claim 9, wherein the controller is configured to control the plurality foldable propulsion units to change at least one of: a pitch angle, a roll angle, and a yaw angle of the rocket.

11. The rocket stage of claim 8, wherein each foldable propulsion unit further comprises at least one servo, and the controller is configured to control the at least one servo to change a pitch of the at least one propeller.

12. The rocket stage of claim 1, further comprising a plurality of stabilizer fins, spaced around a circumference of the body.

13. A rocket system, comprising:
a payload;
a first stage comprising:
a body; and
a plurality of foldable propulsion units spaced around a circumference of the body, and
a second stage.

14. The rocket system of claim 13, wherein the first stage further comprises:
a plurality of foldable airbrakes spaced around a circumference of the body, wherein each airbrake comprises at least one airbrake actuator, configured to actuate the plurality of foldable airbrakes.

15. The rocket system of claim 13, wherein each foldable propulsion unit of the first stage comprises:
a folding beam;
at least one motor mounted to the folding beam, and
at least one propeller mounted to the at least one motor, configured to generate a thrust to propel the rocket.

16. A method of maneuvering a stage of a rocket, comprising:
detecting a first altitude and/or velocity of a rocket stage;
unfolding a plurality of foldable propulsion units of the rocket stage;
activating at least one motor of the foldable propulsion units, and
generating a thrust, via at least one propeller mounted to the at least one motor, in order to maneuver the rocket stage, wherein the rocket stage comprises:
a body; and
the plurality of foldable propulsion units spaced around a circumference of the body, wherein each propulsion unit comprises:
a folding beam;
at least one motor mounted to the folding beam, and
at least one propeller mounted to the at least one motor, configured to generate a thrust to propel the rocket.

17. The method of claim 16, further comprising:
detecting a second altitude and/or velocity of the rocket stage, and
unfolding a plurality of foldable airbrakes, wherein the rocket stage further comprises a plurality of foldable airbrakes spaced around a circumference of the body.

18. The method according to claim 17, wherein unfolding the plurality of foldable airbrakes is controlled by at least one airbrake actuator of the foldable airbrakes.

19. The method of claim 16, wherein unfolding the plurality of foldable propulsion units is controlled by at least one beam actuator of the foldable propulsion units.

20. The method of claim 16, further comprising:
maneuvering the rocket stage, via the at least one propeller, in order to change at least one of: a pitch angle, a roll angle, and a yaw angle of the rocket stage.

21.-26. (canceled)
